(19) United States
(12) Patent Application Publication
(10) Pub. No.: US 2026/0300703 A1
(43) Pub. Date: Oct. 1, 2026

(54) DYNAMICAL MODEL COMPRESSION FOR DEEP NEURAL NETWORKS

(71) Applicant: UNIVERSITY COLLEGE DUBLIN, Dublin 4 (IE)

(72) Inventors: Qingyuan WANG, Dublin (IE); Deepu JOHN, Dublin (IE); Barry CARDIFF, Dublin (IE); Antoine FRAPPE, Dublin (IE); Benoit LARRAS, Dublin (IE)

(21) Appl. No.: 19/478,550

(22) PCT Filed: Apr. 26, 2024
(86) PCT No.: PCT/EP2024/061699

§ 371 Date: Oct. 24, 2025

(30) Foreign Application Priority Data
Apr. 26, 2023 (EP) 23170174.9

(51) Int. Cl. G06N 3/0495; G06N 3/082

(52) U.S. Cl. CPC G06N 3/0495; G06N 3/082

(57) ABSTRACT

Disclosed is a computer-implemented method of dynamically compressing and scaling a base model during run-time, wherein the base model is a deep neural network containing a task-specific head and a backbone divided into a plurality of segments. The method includes providing a plurality of candidate early exit modules and corresponding plurality of candidate threshold values for each segment, heuristically searching a plurality of optimal early exit configurations for the base model, based on a plurality of combinations of accuracy and complexity with respect to the base model, wherein an early exit configuration enumerates which early exit module and what threshold value to be used at output of each segment, loading an optimal early exit configuration onto the base model during run-time, and running the backbone part of the base model segment by segment and ending the run-time at a segment when a confidence value of an output of corresponding early exit module exceeds corresponding threshold value.

### FIELD

The disclosure relates to deep neural networks, and more specifically to compressing deep learning models to dynamically adapt to the real-time demands.

### BACKGROUND

Deep learning (DL) models have proven to be successful in many applications. However, they require a significant number of computations to be performed in a short time. Many portable devices, such as Internet of Things (IoT) devices and smartphones, possess only limited computing and memory resources, and deploying these DL models in resource constrained environments is a challenge. In addition, the runtime latencies and power consumption would be unacceptable when large DL models are deployed in such environments. Even for resource-rich systems such as data centers, some concerns, like the huge energy consumption, remain. Therefore, optimizing model complexity is essential for deploying DL techniques on practical systems.

Several model compression and optimization techniques have been proposed to address the complexity issue. Such techniques usually involve reducing computational precision by quantizing weights or feature maps with fewer bits, pruning inconsequential network connections to reduce computations, creating a smaller model by distilling knowledge from a larger model, developing newer model architectures with lower complexity etc. While all of them are successful at varying levels, they do not consider the ‘input data difficulty’ while optimizing the overall model complexity. In practice, the input data have differences in difficulty. A ‘difficult’ input case may require deep models to obtain acceptable results, but ‘easy’ cases only need smaller (shallower) DL models. However, most existing applications use the same fixed data path for all inputs and waste computation on ‘easy’ inputs. In addition, these model compression techniques generate fixed model variants before the deployment, which necessitate the creation of multiple variants of the same model to support different compression rates for varied real-time performance requirements. In practical scenarios, performance demands can vary over time, and if fixed data path models are used, entire models need to be replaced every time performance targets are changed. This means that the hardware device must store multiple compressed variants of the same model and spend considerable resources to reload different models into memory while applying different compression rates. Storing multiple versions require large space and hot switching between models is difficult.

Further, existing compression methods cannot change the compression rate during the running time. The practical situation as well as the requirement of model performance and complexity vary over time. The applications need to alter their strategy to achieve the maximum power saving while maintaining an acceptable performance. For example, a power hungry data center can normally host services at full speed. However, if there is a power shortage happening, the data center can temporarily downgrade model performance for power saving. Therefore, the model compression methods which are applied to the training and design phase are static, and changing the compression level means repeating the whole process.

The document titled “Multi-exit semantic segmentation networks” by Kouris Alexandros Et al, propose a framework for converting the state of art segmentation CNNs to multi-exit semantic segmentation networks with specially trained models that employ parameterized early exits to save computation and inference cost. EP 3996054 relates to a method for training a machine learning, ML, model to perform semantic image segmentation, and to a computer-implemented method and apparatus for performing semantic image segmentation using a trained machine learning, ML, model.

However, the proposed framework in above-mentioned documents necessitates the expensive training of the backbone part and will produce a new model. The proposed framework cannot be directly applied on existing models and therefore, cannot be considered as a compression method to an existing model. Further, they employ exhaustive search for configurations. With the increase of the number of exit candidates and backbone segments, the searching space will grow exponentially and make the exhaustive search infeasible, especially for the fine-grained trade-off control.

Furthermore, these methods are static, and changing the compression level means repeating the whole process.

In view of the above, there is a need for a system and method that overcomes the above-mentioned disadvantages and facilitates compression of deep learning models to dynamically adapt to the real-time demand.

### SUMMARY OF THE INVENTION

In an aspect of the present invention, there is provided, as set out in the appended claims, a method of dynamically compressing and scaling a deep neural network that includes dividing the deep neural network into a plurality of segments, and a head network connected to a last segment of the plurality of segments, connecting at least one early exit to an output of each segment during run-time, based on an early exit configuration that is determined dynamically during the run-time based on a target accuracy and complexity, and ending the run-time and exiting the deep neural network from an early exit, and setting an output of said early exit as a final output of the deep neural network, when said early exit reports a confidence value higher than an associated threshold.

In another aspect of the present invention, there is provided a computer-implemented method for dynamically compressing and scaling a base model during run-time, wherein the base model is a deep neural network containing a task-specific head and a backbone, wherein the backbone is divided into a plurality of segments. The computer-implemented method includes providing a plurality of candidate early exit modules and corresponding plurality of candidate threshold values for each segment, wherein an early exit module is configured to be connected to an output of a segment, to enable early exiting of the base model from said segment when an intermediate output of the early exit module reports a confidence value higher than associated threshold value; heuristically searching a plurality of optimal early exit configurations for the base model, based on a plurality of combinations of accuracy and complexity with respect to the base model, wherein an early exit configuration enumerates which early exit module and what threshold value to be used at output of each segment, loading an optimal early exit configuration onto the base model during run-time, to connect at most one early exit module to each segment according to said configuration, and running the backbone part of the base model segment by segment and ending the run-time at a segment when a confidence value of an output of corresponding early exit module exceeds corresponding threshold value.

In an embodiment of the present invention, the computer-implemented method further includes switching among the plurality of optimal early exit configurations during run-time to implement dynamic compression and scaling of the base model to meet real-time demand of the user.

In an embodiment of the present invention, the plurality of candidate early exit models has varying sizes and architectures with respect to each other.

In an embodiment of the present invention, the computer-implemented method further includes freezing the base model for training the plurality of candidate early exit models at each segment collectively or individually based on a training dataset similar to that used for training the base model.

In an embodiment of the present invention, each early exit module comprises an early exit function for receiving an output of a previous segment and generating an intermediate output, and a decision function for deciding whether to exit early or not by comparing a confidence value of the intermediate output with an associated threshold value, continuing the computation to a next segment, when the confidence value is less than the associated threshold, and exit the computing from the backbone network with the intermediate output as a final output, when the confidence value is greater than or equal to the associated threshold.

In an embodiment of the present invention, the heuristic searching comprises employing a circular search that includes initiating an empty early exit configuration, and modifying early exit module and associated threshold value of each segment in a circular fashion iteratively till an object function of said configuration is not minimizable further, wherein the object function is proportional to a trade-off factor, and complexity and accuracy of said configuration relative to that of the base model, and wherein the trade-off factor is a parameter to control weighting of the accuracy and complexity.

In an embodiment of the present invention, the heuristic searching comprises employing a singular search that includes initiating an empty early exit configuration, and modifying early exit module and associated threshold value of first to last segments sequentially to obtain an early exit configuration with minimized object function.

In an embodiment of the present invention, the computer-implemented method further includes storing the plurality of optimal configurations with simulated compression rate, accuracy loss, and trade-off factors, with respect to that of the base model on a common training dataset.

In an embodiment of the present invention, the complexity and accuracy of an early exit configuration is directly proportional to threshold values of corresponding early exit modules.

In an embodiment of the present invention, the computer-implemented method further includes using an independent model as the first exit of the base model, such that the independent model receives the same input as the base model and is pretrained on a task similar to that of the base model, and providing an exit sequence network between backbone networks and the plurality of exit modules such that the plurality of early exit modules is connected to different positions of the exit sequence network, wherein the exit sequence network includes a plurality of sequential layers to provide aggregated features from the independent model and the plurality of backbone segments, to the plurality of early exit modules.

In an embodiment of the present invention, the exit sequence network comprises a plurality of feature embedding layers to convert the features from the independent model and backbone segments to a uniform format.

In another aspect of the present invention, there is provided a system for dynamically compressing and scaling a base model during run-time, wherein the base model is a deep neural network containing a task-specific head and a backbone, and wherein the backbone is divided into a plurality of segments. The system includes a memory to store one or more instructions, and a processor configured to execute the one or more instructions stored in the memory to: provide a plurality of candidate early exit modules and corresponding plurality of candidate threshold values for each segment, wherein an early exit module is configured to be connected to an output of a segment, to enable early exiting of the base model from said segment when an intermediate output of the early exit module reports a confidence value higher than associated threshold value; heuristically search a plurality of optimal early exit configurations for the base model, based on a plurality of combinations of accuracy and complexity with respect to the base model, wherein an early exit configuration enumerates which early exit module and what threshold value to be used at output of each segment, load an optimal early exit configuration onto the base model during run-time, to connect at most one early exit module to each segment according to said configuration; and run the backbone part of the base model segment by segment and end the run-time at a segment when a confidence value of an output of corresponding early exit module exceeds corresponding threshold value.

In yet another aspect of the present invention, there is provided a non-transitory computer readable medium having stored thereon computer-executable instructions which, when executed by a processor, cause the processor to divide a base model into a task-specific head and a backbone comprising a plurality of segments, provide a plurality of candidate early exit modules and corresponding plurality of candidate threshold values for each segment, wherein an early exit module is configured to be connected to an output of a segment, to enable early exiting of the base model from said segment when an intermediate output of the early exit module reports a confidence value higher than associated threshold value, heuristically search a plurality of optimal early exit configurations for the base model, based on a plurality of combinations of accuracy and complexity with respect to the base model, wherein an early exit configuration enumerates which early exit module and what threshold value to be used at output of each segment, load an optimal early exit configuration onto the base model during run-time, to connect at most one early exit module to each segment according to said configuration, and run the backbone part of the base model segment by segment and ending the run-time at a segment when a confidence value of an output of corresponding early exit module exceeds corresponding threshold value.

Various embodiments of the present invention provide a dynamic model compression and dynamic complexity scaling technique using early exits. The present invention provides a groups of early exit networks to an existing deep learning model to achieve dynamical model compression in fine grain, satisfying the real-time demand. The dynamic compression method performs optimized approaches for organizing multiple early exits for arbitrary targets and therefore enabling dynamic model scaling during the inference phase. The early exit configurations are generated based on arbitrary trade-offs between performance and computational complexity to provide a nearly continuous set of fine-grained performance-tuning options. The exit condition can be varied during inference to achieve complexity scaling while meeting real-time performance requirements. This makes the DL model fully flexible, supporting on-demand performance, and the original performance fully restorable if and when required. The dynamic model compression method includes a systematic approach to employ groups of exits to achieve arbitrary compression levels, which includes storing smalling early exit networks instead of storing multiple versions of a model. The configuration switching which involves loading early exits or even changing thresholds only is much easier than reloading the whole network. The dynamic compression method enables dynamic inference data paths based on the difficulty of the input sample. Here, the inference of an input sample would exit early if the early exit from an intermediate layer generates an acceptable result. Thus ‘simpler’ inputs only pass through a partial network, saving all remaining computations on the rest of the network. The dynamic compression method enables dynamic model scaling to address real-time changes in performance-complexity demands by changing the configuration of early exits. The dynamic compression method not only use less computation to achieve similar performance, but the compression scale is configurable during the run-time. The users can choose the configuration to suit their real-time demand with the minimum complexity exactly. This method can reduce the huge power consumption caused by deep networks while satisfying the real-time demand for different applications, from battery powered mobile devices to energy-hungry data centres.

Further, the system and method of the present invention may be applied to any existing pre-trained deep neural networks retrospectively and compress them dynamically. The system and method don't not need any specific model architecture or co-designed training processes for early-exit and base model, as compared to the state of the art, where the base model and early exits are designed and trained from scratch. Furthermore, the system and method support switching configurations in real-time to suit varying demand precisely. Furthermore, the system and method assign a threshold value to each exit module, enabling precise control of each exit, as compared to the state of the art, where one threshold value is assigned to all exits. Furthermore, the efficient heuristic searching algorithm may yield a plurality of configuration of different trade-off preferences in fine-grain at one time, so that it supports search-once-deploy-anywhere.

### BRIEF DESCRIPTION OF THE DRAWINGS

The invention will be more clearly understood from the following description of an embodiment thereof, given by way of example only, with reference to the accompanying drawings, in which:—

FIG. 1A illustrates an overview of a dynamic model compression system, in accordance with an embodiment of the present invention;

FIG. 1B illustrates a segmented backbone network and a set of early exits attached to the backbone network in detail, in accordance with an embodiment of the present invention;

FIG. 2 illustrates a run-time inference algorithm for dynamic model compression of the deep neural network, in accordance with an embodiment of the present invention;

FIG. 3 illustrates accuracy and predictions having higher confidence than the threshold by an early exit;

FIG. 4 illustrates accuracy and its conservative estimation and exiting rate with respect to different thresholds by an early exit, in accordance with an embodiment of the present invention;

FIG. 5 illustrates a circular search algorithm for searching an early exit configuration, in accordance with an embodiment of the present invention;

FIG. 6 illustrates a single search algorithm for searching early exit configuration, in accordance with an embodiment of the present invention;

FIG. 7 is a flowchart illustrating a method of applying dynamic model compression to a deep learning model, in accordance with an embodiment of the present invention;

FIG. 8 shows a table illustrating required Multiply-Accumulate Operations (MACs) indicative of complexity, when a certain Accuracy drop is allowed, while implementing dynamic model compression on different networks with different datasets;

FIGS. 9A, 9B and 9C illustrate performance of searched configuration and stand-alone early exits for three different types of neural networks ResNet 34, ResNet 50 and ResNet 152 respectively on dataset such as CIFAR-10;

FIGS. 10A, 10B and 10C illustrate performance of searched configuration and stand-alone early exits for three different types of neural networks ResNet 34, ResNet 50 and ResNet 152 respectively on dataset such as ImageNet; and

FIG. 11 illustrates integration of a tiny saver model and an exit sequence network with the base model, in accordance with an embodiment of the present invention.

### DETAILED DESCRIPTION OF THE DRAWINGS

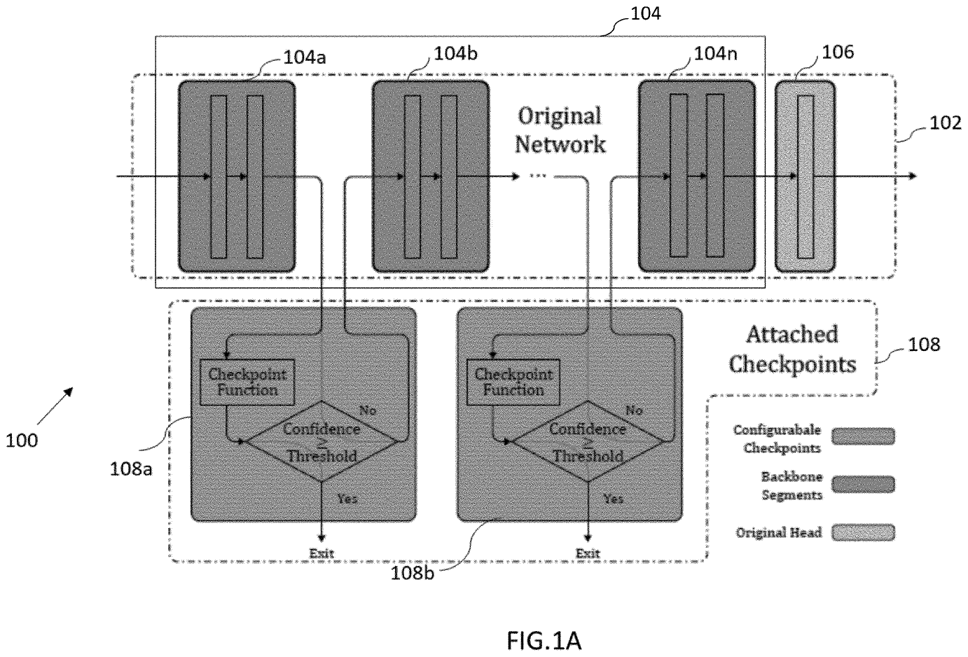

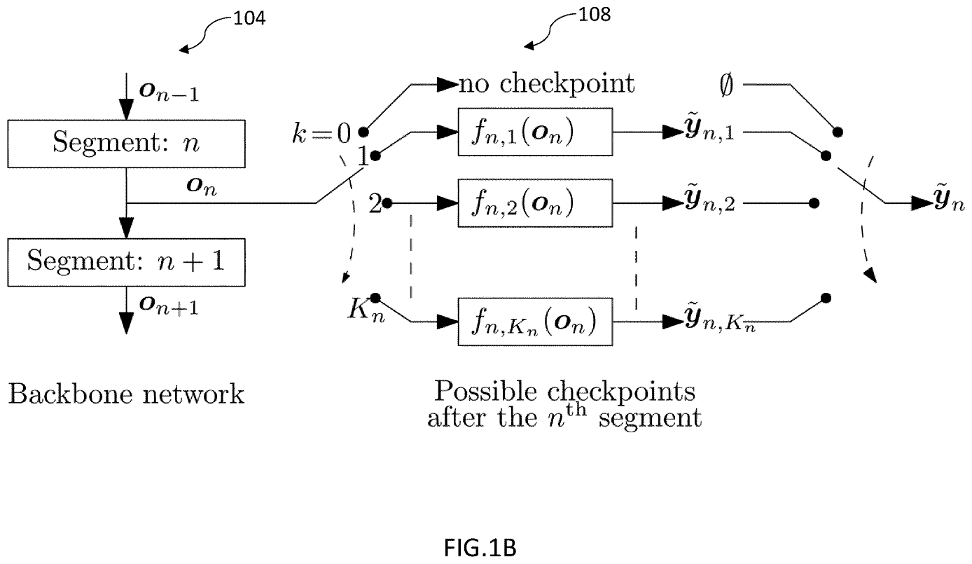

FIG. 1A illustrates an overview of a dynamic model compression system 100, in accordance with an embodiment of the present invention. The dynamic model compression system 100 includes an original deep neural network 102 that is formed of a backbone network 104 and a head network 106. The backbone network 104 includes first through last backbone segments 104a till 104n, wherein the head network 106 is connected to the last backbone segment 104n. The backbone network 104 performs feature extraction and the head network 106 forms a small network at the end for the final output. The backbone part is typically stacked as multiple dividable hidden layers. Therefore, the backbone of the original deep neural network 104 is divided into N segments. The nature of this segmentation could be fine or granular. The deep neural network 102 may be hereinafter also referred to as a base model.

The dynamic model compression system 100 further includes a plurality of early exit modules 108a and 108b, each attached to an end of corresponding backbone segment. In an example, a first exit module 108a is attached to an end of the first backbone segment 104a, a second exit module 108b is attached to an end of the second backbone segment 104b, and so on. Although, two early exit modules 108a and 108b are being shown herein, it would be apparent to one of ordinary skill in the art, that there may be more than two early exit modules, such that ends of each of first through (N−1)^{th} backbone segments are connected to respective exit modules. The exit modules 108a and 108b (hereinafter collectively referred to as early exit modules 108) are attached to hidden layers of the original network 102 for producing an early estimate of the final result.

At each early exit module, the output of corresponding backbone segment is processed through an early exit function to generate a confidence level of the output. When the confidence level driven from the output of the early exit function is greater than or equal to its associated threshold, the inference will exit immediately. Else, it passes the output of the previous backbone segment to the next backbone segment. It is to be noted that the early exit functions and their thresholds are configurable to adapt to varying performance-complexity targets. The early exiting is a fast inference technique that uses acceptable intermediate outputs as estimates of final results and terminates the model inference in the early layers of the deep learning model 102.

The inference process would be concluded at an early layer if the output generated from an early exit is acceptable. This approach saves computations in the remaining layers and results in a smaller, lower complexity model for ‘easier’ to process input data. For more ‘difficult’ to process input data, inference computations at further layers would be activated until an acceptable result is obtained at a later exit or completely executes all model layers. The proposed system 100 is compatible and can be used in conjunction with other compression techniques.

FIG. 1B illustrates a backbone network 104 and a set of early exit modules 108 attached to the backbone network 104 in detail, in accordance with an embodiment of the present invention.

The backbone network 104 is shown to include an n^{th} backbone segment and an (n+1)^{th} backbone segment, and a set of k^{th} possible candidate early exit modules after the n^{th} backbone segment. The output of the n^{th} and (n+1)^{th} backbone segments may be referred to as oₙ and oₙ₊₁ respectively. At run-time, at most one of Kₙ candidate early exit functions, indexed by k, can be applied to the output of the n^{th} backbone segment, whose task is to make an early estimate of the output of the network 102. The output \tilde{y}_{n,k} of an early exit k for n^{th} segment may be referred by the following equation:

$${\tilde{y}}_{n , k} = {f}_{n , k} ( {o}_{n} ) \qquad ( 1 )$$

where \tilde{y}_{n,k} refers to an intermediate output of k^{th} early exit, and that has the compatible format as the original network's output oₙ. Each of the early exit functions may be designed and trained offline independently of any other and may be fixed at run-time. Note that \tilde{y}_{n,k} may be compatible with the original network's output but not necessarily in exactly the same format. It could for example be shorter, providing classification results for a sub-set of classes, or perhaps some clustering of classes. The output of the k^{th} early exit for n^{th} segment may be referred to as \tilde{y}ₙ. For ease of description, the pre-trained head network 106 at the end of the original base model, may be denoted as the final ‘early exit’ ƒ_{N,1}. The samples that do not exit early would eventually pass through this final exit 106.

In an embodiment of the present invention, a confidence value may be determined for each output (\tilde{y}_{n,k}) of each check point function. The confidence value of an output may be an estimate of correctness of the output. For classification problems, the confidence may be the maximum value of the predicted class probability, i.e.: max(\tilde{y}_{n,k}). Further, a threshold t may be applied to each confidence value, in order to make an early-exit decision. A high threshold limits an exit such that only highly confident samples exit early, and a lower threshold would allow more samples to exit early. Accordingly, the threshold t can be adjusted to obtain different complexity/accuracy trade-offs.

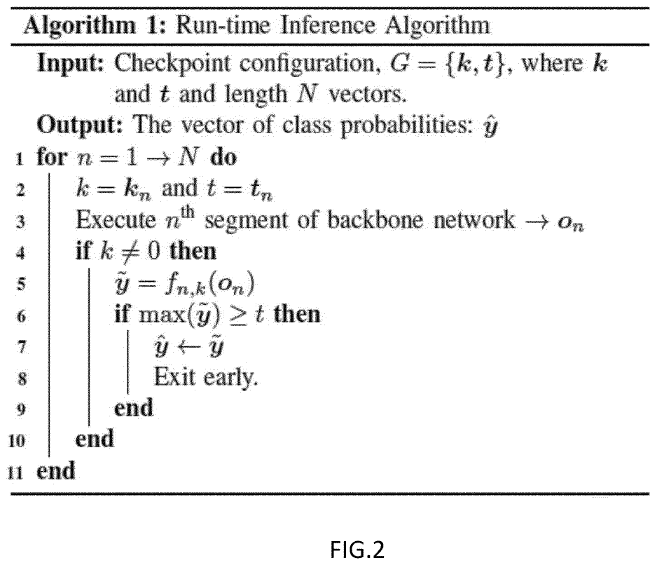

FIG. 2 illustrates a run-time inference algorithm for dynamic model compression of the deep neural network 102, in accordance with an embodiment of the present invention. The early exit modules may be applied to the backbone segments based on pre-defined early exit configuration groups, that enumerate which early exit function and what threshold value to be used at the output of each segment. A early exit configuration may be referred to as G={k, t} and comprise a length N ordered list of function indices, k and thresholds t, such that the early exit to be used after the n^{th} segment is ƒ_{n,k}_{ₙ} i.e. \tilde{y}ₙ≙\tilde{y}_{n,k}_{ₙ}, and the corresponding confidence is max(\tilde{y}_{n,k}). Thus, the configuration enables early exits at multiple positions of the deep learning model. The model confidence means an estimate of result correctness from the model itself. For classification problems, the confidence can be interpreted as the maximum value of the predicted probabilities, which is max (\tilde{y}_{n,k}). This confidence is then compared against corresponding threshold tₙ in order to make an early-exit decision. The threshold t is a pre-defined value that controls which samples should exit. A high threshold limits an early exit to exit high confident samples only, and a low threshold would exit most samples. If the confidence is greater than or equal to corresponding threshold value, i.e. max(\tilde{y}ₙ)≥tₙ, the computation is terminated (early exited) and the prediction will be the most likely class given by this early exit i.e. argmax(\tilde{y}ₙ). Note that k_{N} is set to be 1 and t_{N}=0 forcing the last ‘early exit’ 106 to always execute, providing a final decision, ƒ_{N,1} and forcing an exit at that ‘early exit’ 106 for all samples that haven't previously exited early.

In an embodiment of the present invention, the design of an early exit is based on the trade-off between complexity and performance. Although more complex networks have higher stand-alone performance, they would introduce more overhead and can affect the system's overall performance. One of the simplest forms of an early exit is the multilayer perceptron. However, any functions that can generate a compatible output are eligible early exit functions. Meanwhile, since every early exit is independent of others, there is no requirement for all early exits to have the same architecture. They can be designed and trained separately. It is also possible to design multiple candidate early exits for the same position. The searching algorithm (discussed later) may find the most suitable one for different targets. Herein, small Multilayer Perceptrons (MLPs) may be used as early exits to generate results. An average pooling layer may be employed before the first MLP layer to reduce the feature map's height and width to 1.

Referring to FIG. 1A, it is to be noted that during the training process, the original base model 102 is frozen, and only the early exit network 108 is trained. The freezing the original network 102 ensures that the system can restore full performance at any time since the original model is left untouched. It also ensures that all early exits are independent of each other and the original network 102 because they do not share any region of the network. Since the training of each early exit is isolated, multiple early exits may be trained together or separately with the same or different training methods. Meanwhile, as the design and positions are different, some exits may need longer training than others. In the context of the present invention, the training of those exits is stopped whose loss is no longer reducing and let the other training continue until a maximum epoch limit.

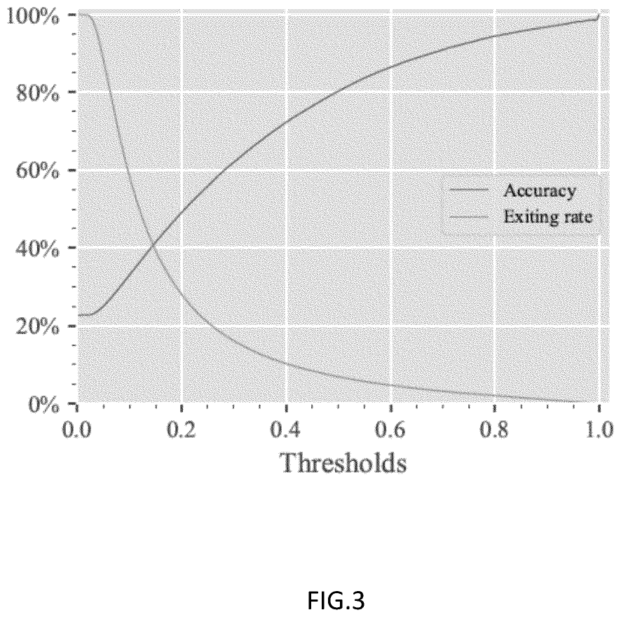

FIG. 3 illustrates accuracy and predictions having higher confidence than the threshold by an early exit. As the threshold increases, fewer samples exit at this point, while the accuracy rises.

In an embodiment of the present invention, the stand-alone performance of an early exit might be not high because it may be attached to an initial segment and prior backbone segments (layers) may not be originally designed to support this exit. However, when a group of early exits is used, the cooperation of early exits can avoid a large art of incorrect predictions. As shown in FIG. 3, an early exit would exit fewer samples within the increasing threshold, but these predictions are more accurate. This observation indicates that though the early exits' stand-alone accuracy may not be satisfying, their high-confidence predictions are still trustworthy. In a group of early exits with high thresholds applied, samples may exit by either a highly confident early exit or the final exit. In this case, the overall accuracy may be maintained at a high level while some complexity has been saved.

In an embodiment of the present invention, the number of possible early exits combination is

$${\prod }_{n = 1}^{N - 1} ( {K}_{n} + 1 ) ,$$

with an associated threshold. Therefore, an algorithm is provided for selecting which one of the huge number of early-exit configuration possibilities should be used under a specific constraint. The configuration searching consider two aspects, performance and complexity. In the present approach, they are defined as the overall accuracy, and relative value of MAC operations to the original network. In this invention, the accuracy and complexity are measured relative to the original model. The overall accuracy of a configuration relative to the accuracy of original model may be defined as A(G) and the overall number of MAC (multiply-accumulate) operations relative to the MAC of original model may be defined as C(G).

This system may consider the trade-off between performance and complexity in a fine grain. The trade-off factor λ may be defined to control the weight between performance and complexity. The optimized configurations may be heuristically searched by minimizing the object function ƒ(G, λ)=λ(1−A(G))+(1−λ)C(G). Every trade-off factor 2 may result in a different configuration. By traveling λ with a small step, this invention can provide nearly continuous options of performance and complexity.

The overall accuracy may be basically computed by summarizing correct predictions of any early exits dividing by the dataset size. Concretely, supposing that the backbone network 104 includes N segments and a dataset includes M samples. By executing the inference algorithm (as described in FIG. 2) on that dataset, for every sample, every early exit output in a configuration G={k, t} may be recorded as \tilde{y}_{n,k}_{ₙ} and the predicted probability of i^{th} class for m^{th} sample may be represented as

$${\tilde{y}}_{n , {k}_{n}}^{( m , i )} .$$

The set Wₙ(k, t) is defined to be including indices of samples that have higher confidence than the corresponding threshold tₙ at n^{th} early exit. Uₙ(k, t) is Wₙ(k, t) excluding any previously exited samples, i.e., indices of samples which are exited by n^{th} early exit. Vₙ(k, t) is a subset of Uₙ(k, t) where every prediction is correct. These variables may be defined mathematically in Equations (2), (3) and (4).

$${W}_{n} ( k , t ) = \{ m : max {\tilde{y}}_{n , {k}_{n}}^{( m , i )} \geq {t}_{n \}} \} \qquad ( 2 )$$

$${U}_{n} ( k , t ) = {W}_{n} ( k , t ) / {⋃}_{{n}^{′} = 1}^{n - 1} {W}_{n ′} ( k , t ) \qquad ( 3 )$$

$${V}_{n} ( k ) = \{ m : arg {max}_{i} ( {\tilde{y}}_{n , {k}_{n}}^{( m , i )} ) = {\tilde{y}}^{( m , i )} \} \qquad ( 4 )$$

where the maximisation above is done over all possible classes (indexed by i). The number of samples that reach and exit from the n^{th} early exit of configuration G={k, t} may be counted as Eₙ={k, t} and the number of these that are correct may be counted as ECₙ={k, t}

$${E}_{n} ( k , t ) = \vert {U}_{n} ( k , t ) \vert \qquad ( 5 )$$

$${EC}_{n} ( k , t ) = \vert {U}_{n} ( k , t ) ⋂ {V}_{n} ( k ) \vert \qquad ( 6 )$$

where |S| means the cardinality of a set S.

Normally, the accuracy may be measured by the corrected predictions over the total, i.e.,

$$\frac{E {C}_{n} ( k , t )}{{E}_{n} ( k , t )} .$$

However, when the threshold of an early exit is high, and it only exits a few samples, the sample mean estimation of accuracy may be unreliable as the number of samples is too small. For example, in FIG. 3, there may be a sudden increase of accuracy to 100% when the threshold is close to 1. Therefore, the sampled mean may be replaced with a conservative value as the estimation of an early exit. It may be assumed that the accuracy of an early exit in a specific configuration Aₙ(k, t) obeys the Beta distribution.

$${A}_{n} ( k , t ) ∼ Beta ( 1 + a , 1 + b - a ) \qquad ( 7 )$$

where a=|Eₙ(k, t)|, the number of predictions made by n^{th} early exit, and b=|ECₙ(k, t)| is the number of correct predictions.

Then, the probability of Aₙ(k, t) may not be greater than x by the cumulative distribution function (CDF) Iₓ of the Beta distribution.

$$P ( {A}_{n} ( k , t ) \leq x ) = {I}_{x} ( 1 + a , 1 + b - a ) \qquad ( 8 )$$

A conservative estimation of Aₙ(k, t) is computed by the inverse Beta CDF

$${I}_{P}^{- 1}$$

such that the true value is most likely (90%) being higher than it.

$${A}_{n} ( k , t ) = {I}_{0.1}^{- 1} ( 1 + a , 1 + b - a ) \qquad ( 9 )$$

Now, the overall accuracy may be defined as:

$$A ( k , t ) = \frac{1}{M} {\sum }_{n = 1}^{N} \vert {E}_{n} ( k , t ) \vert {A}_{n} ( k , t ) \qquad ( 10 )$$

Comparing with the normal way to calculate the accuracy. This approach penalizes the accuracy metric if the number of samples is insufficient. It would not make any difference if the dataset is huge, but it would make the search algorithm more robust for small datasets.

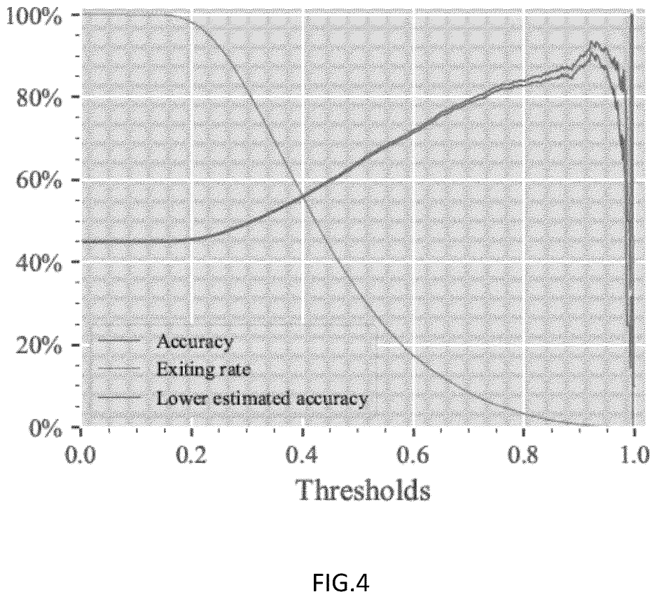

FIG. 4 illustrates accuracy and exiting rate with respect to different thresholds by the first early exit (located at 1^{st} connection's output) of a deep neural network, in accordance with an embodiment of the present invention. The lower estimated accuracy excludes the unreliable accuracy when the threshold is high. There is a huge fluctuation in the directly measured accuracy when the threshold is higher than 0.9. However, this area cannot represent the true performance in practice as it is observed from a very limited number of samples. The lower estimation of accuracy can penalize these less significant results such that the irregular high accuracy would not mislead the search algorithm.

In an embodiment of the present invention, the number of MAC operations in a given functional block with respect to the total number of MAC operations in the original network is referred to as complexity. The following normalised complexity measures are defined. Let Sn be the complexity of the n^{th} segment alone. Accordingly,

$${\sum }_{n = 1}^{N} {S}_{n} = 1 , 2 ) .$$

Let Δ_{n,k}>0≥0 be the complexity of the early exit function ƒ_{n,k}. Note that Δ_{n,0}=0 for all n as this is the ‘no early exit’ i.e. early exit disabled, option. Then the average run-time complexity of a configuration is defined as:

$$C ( k , t ) = \frac{1}{M} {\sum }_{n = 1}^{N} {E}_{n} ( {k}_{n} , {t}_{n} ) {\sum }_{n ′ = 1}^{n} ( {S}_{n ′} + {Δ}_{{n}^{′} , {k}_{{n}^{′}}} ) \qquad ( 11 )$$

In an embodiment of the present invention, the model compression takes into account of both performance and complexity. The proposed dynamical compression method is designed to generate a series of configurations that have different importance to the performance and complexity. Both the factors may be summarized with a parameter λ into the following target function:

$$f ( k , t , λ ) \hat{=} λ ( 1 - A ( k , t ) ) + ( 1 - λ ) C ( k , t ) \qquad ( 12 )$$

Where 0≤λ≤1 is a user-controlled parameter to adjust the relative importance of accuracy and complexity, i.e., as λ→1, a minimization process would maximize the accuracy with no consideration to the complexity cost. Conversely, as λ→0, solutions with minimal complexity would be found at the cost of accuracy. This function may be used as the target of a minimization algorithm.

In another embodiment of the present invention, a configuration is to be determined that minimizes the average cost for a specified λ. A brute force algorithm is not feasible due to the enormous number of possible early exit configurations coupled with the complexity of evaluating the average cost for each. Therefore, two search approaches have been proposed using the acceptable time to find configurations with a given λ.

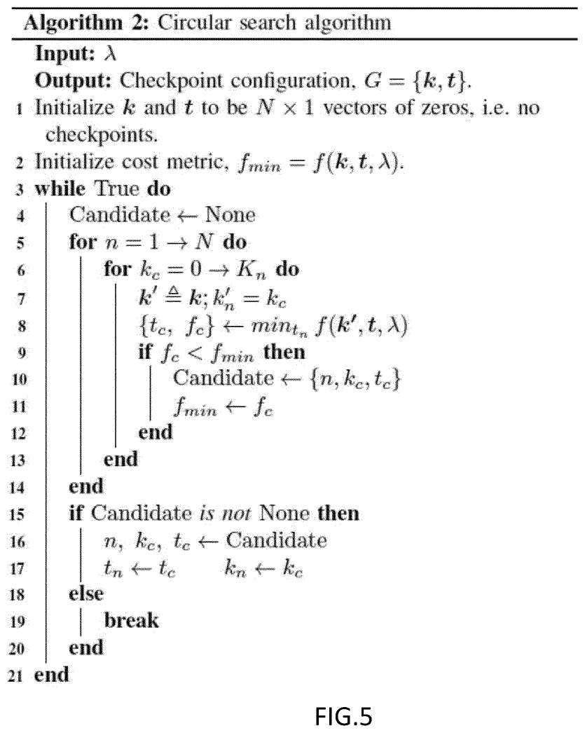

FIG. 5 illustrates a circular search algorithm for heuristically searching an early exit configuration, in accordance with an embodiment of the present invention.

The circular search starts with searching with an empty early exit configuration. For every iteration, every possible early exit at every position is gone through, and one modification is updated with the lowest object value ƒₘᵢₙ to the current configuration. The iteration would continue until it cannot find any modifications to make ƒₘᵢₙ lower, where

$${min}_{{t}_{n}} f ( {k}^{′} , t , λ )$$

is bounded by minimization algorithm to find a t_{c}∈(0, 1) and make the function value minimized to ƒ_{c}.

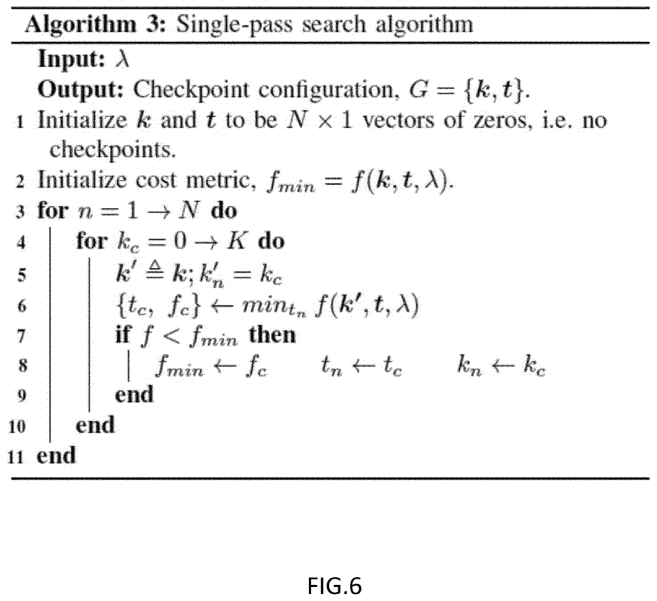

FIG. 6 illustrates a single search algorithm for heuristically searching an early exit configuration, in accordance with an embodiment of the present invention. The circular search algorithm might be time-consuming when the dataset is large. The single search algorithm may only pass once from the first segment to the last. The algorithm starts by assuming an empty configuration, beginning with the first possible early exit position (n=1) and adding the option to help the configuration achieve the lowest ƒₘᵢₙ. With this modification taken into use, the next early exit position is considered until n=N, i.e., a single-pass can be made through all possible early exit positions. The single-pass algorithm dramatically reduces the searching time, and the present experiment indicates that the single-pass algorithm can usually finish in minutes without negatively impacting results.

The search algorithm's result is a specific configuration with a complexity/performance trade-off determined by the parameter λ. This searching process can be repeated with various values of λ to yield other configurations having different trade-off characteristics. A device, which finally uses this model for inference, can store several pre-defined configurations and switch among them at run-time to implement a dynamical model compression depending on the real-time situation. Thus, it is possible to switch among the several pre-defined early exit configurations during run-time to implement dynamic compression and scaling of the original base model to meet real-time demand of the user.

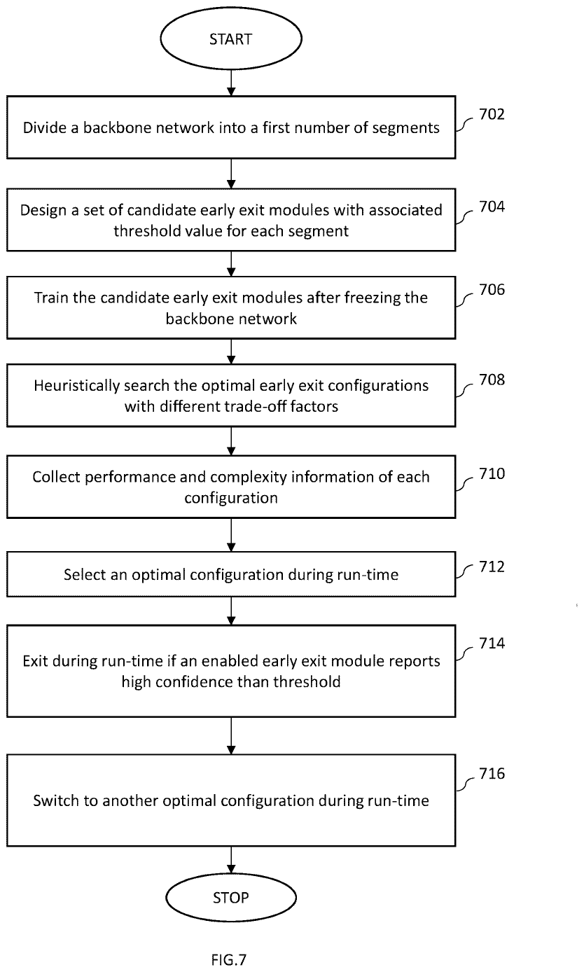

FIG. 7 is a flowchart illustrating a method of applying dynamic model compression to a deep learning model, in accordance with an embodiment of the present invention.

At step 702, an existing deep learning model is divided into a first number of segments. The deep learning model is pre-trained.

At step 704, a set of candidate early exit modules are designed for each segment with corresponding plurality of candidate threshold values. Each candidate early exit module is configured to be connected to an output of a segment, to enable early exiting of the base model from said segment when an intermediate output of the early exit module reports a confidence value higher than associated threshold value.

At step 706, the existing deep learning model is frozen, the set of early exit modules of the given segment are trained, and the outputs of all early exits are recorded on the training dataset. Also, the early exits may be grouped into various early exit configurations to obtain the required trade-off. Each early exit configuration guide which early exits are enabled, and the condition of exiting at those early exits.

At step 708, a plurality of optimal early exit configurations is heuristically searched based on a plurality of combinations of accuracy and complexity with respect to the base model. Each early exit configuration enumerates which early exit module and what threshold value to be used at output of each segment.

At step 710, the performance and complexity information of each optimal configuration is collected and stored with respective trade-off factor, wherein the trade-off factor is a parameter to control weighting of the accuracy and complexity.

At step 712, the early exit configuration which has suitable performance and complexity is being selected during inference run time.

At step 714, the configuration is exited during run-time once an enabled early exit reports high confidence than corresponding threshold. More computations may be spent on those inputs that cause the early exits to have less confidence regarding early-exit decisions, i.e. difficult inputs, while easy inputs are mostly exited at early stages.

At step 716, another early exit configuration is chosen if the demand has changed. Thus, it is possible to switch among the plurality of optimal configurations at run-time to achieve dynamic compression and scaling of the base model to meet real-time demand of the user. The demand constitutes computational complexity (energy consumption) and accuracy. The demand changes based on the application, for example, the user may choose a low complexity configuration when the battery is running out and a high accuracy one if the accuracy is very important.

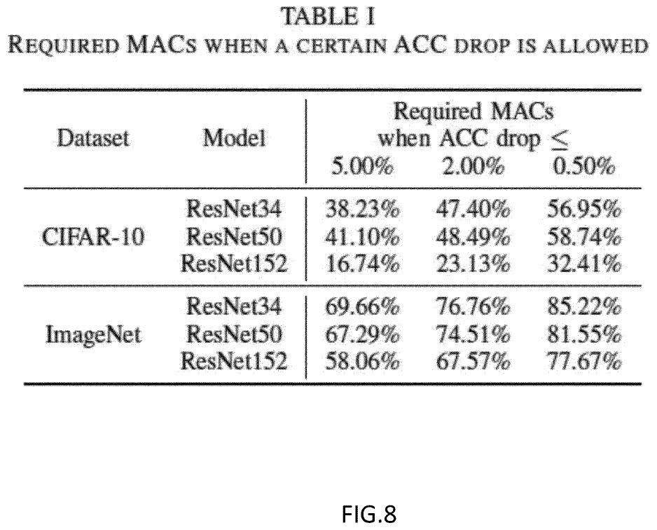

FIG. 8 shows a table illustrating required MACs (indicative of complexity) when a certain Accuracy drop is allowed, while implementing dynamic model compression on different networks with different datasets. It can be seen that as a compression method, dynamic model compression has the ability to save computation with minor cost. As Table I shows, the proposed system only needs 85.22%, 81.55% and 77.67% of MACs to maintain the same level of accuracy (drop≤0.5%) for three database variants on a deep learning model such as ImageNet. For the task, that model is more redundant to, CIFAR-10, it only requires 56.95%, 58.74% and 32.41% of MACs for achieving similar accuracy. If more accuracy drops are allowed, the dynamic compression model can further reduce the computation by about 15% to 20% within 5% loss in accuracy.

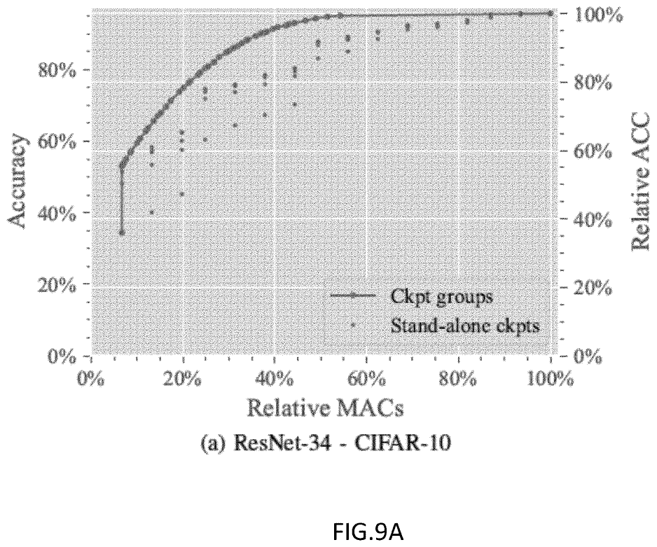

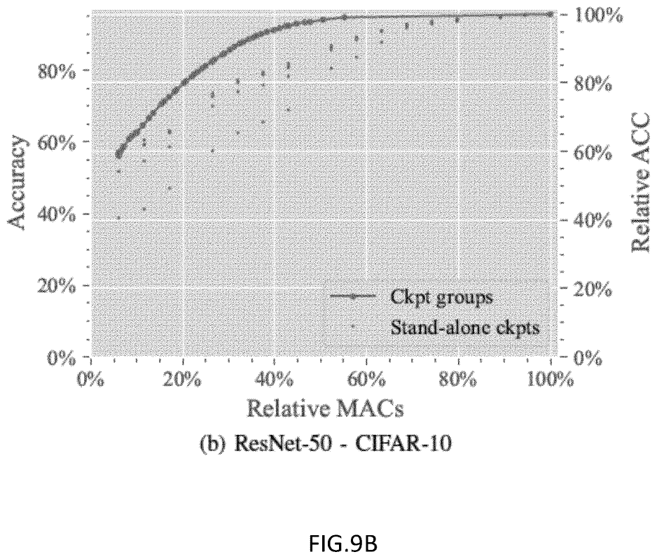

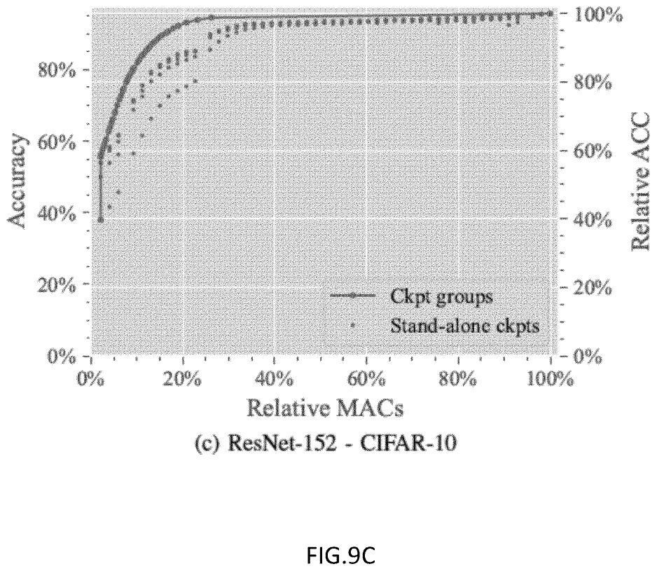

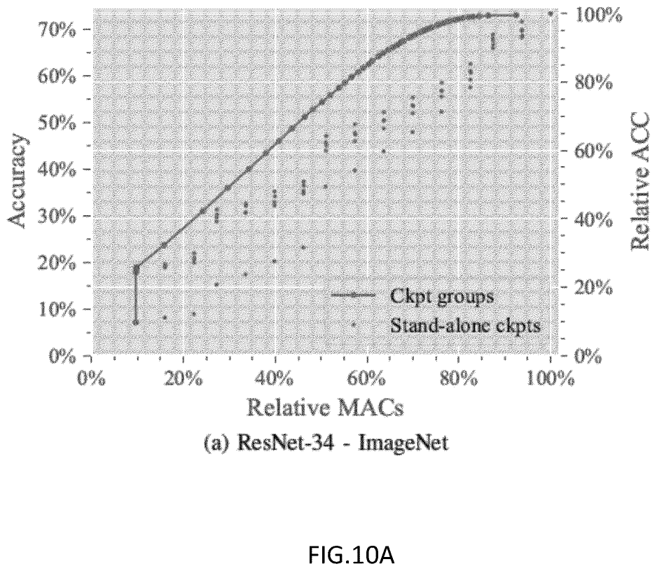

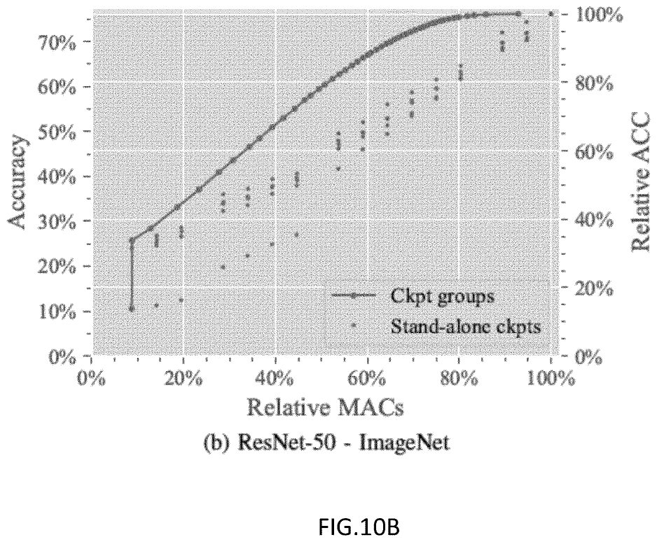

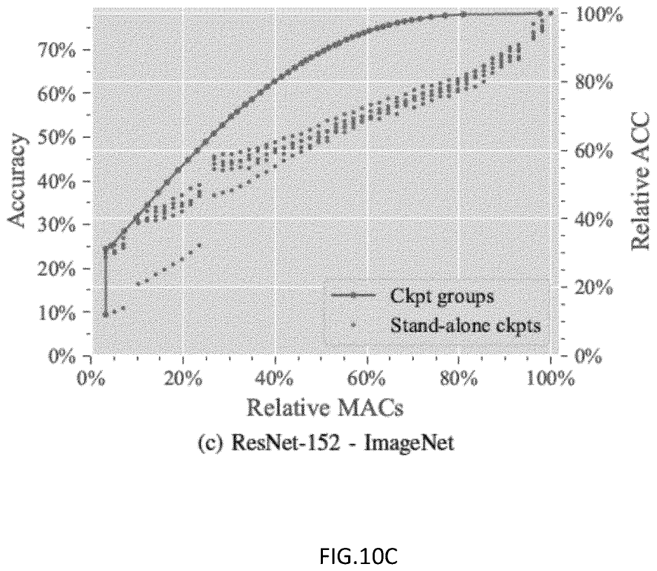

FIGS. 9A, 9B and 9C illustrate performance of searched configuration and stand-alone early exits for three different types of neural networks ResNet 34, ResNet 50 and ResNet 152 respectively on dataset such as CIFAR-10. FIGS. 10A, 10B and 10C illustrate performance of searched configuration and stand-alone early exits for three different types of neural networks ResNet 34, ResNet 50 and ResNet 152 respectively on dataset such as ImageNet.

Another feature of Dynamic compression model (DyCE) is supporting the dynamically configurable scaling, as different λ would result in configurations with varying compression preferences. The top curves in FIGS. 9A-9C and 10A-10C represent configurations that the user can choose during the run-time. Each curve is generated by different λ with 0.01 interval, but more configurations can be created with denser/so the system can configure its trade-off in a nearly continuous schema. Also, an attempt has been made to demonstrate the ability of many early exits working together (the top curve) to out-perform individual stand-alone exits (bottom dots). To obtain the stand-alone performance, a configuration is simulated with just one early exit enabled and its threshold is set to zero to always exit at that point. This is then repeated for all possible early exits yielding the family of ‘bottom dots’. This illustrates, for example, in FIG. 10C, that at a complexity target of 40%, the best available individual early exit only has an accuracy of ≈50%, whereas there is group of early exits available that would yield an accuracy of ≈60%. Alternatively, an accuracy target of, for example, 60%, can be considered, and it could only be achieved with a complexity of ≈80% using stand-alone early exits. In contrast, there is group of early exits available. By altering early-exit configurations, the proposed system can be dynamically configured to scale model complexity during run-time to meet real-time performance requirements. The ResNet152's complexity is scaled from 16.74~32.41% on CIFAR-10 and 58.06~77.67% on ImageNet, with the accuracy loss of 5.0~0.5%. that would yield the required accuracy with only 40% complexity. This demonstrates that an early exit configuration's performance is not just a weighted sum of all its enabled early exits' performances.

The performance curves have illustrated that the extra computation, is negligible compared to the overall reduction. The additional memory is necessary to store early exit networks. While its amount can also be limited in practice as applications may not require the full range of performance or the high density of configurations. On the other hand, storing some small exit networks is still saving compared with storing other model variants for a system requiring varying performance.

It is to be apparent to one of ordinary skill in the art, that the dynamic compression (DyCE) method is demonstrated with the example of image classification. However, DyCE can be built in alternative ways and deployed to more applications for more tasks. There should be no barriers to adapting DyCE to other tasks and hierarchical models. DyCE can be applied to any models that are dividable along the depth if the early exit can be designed to generate a candidate prediction in a compatible format as the original output and produce prediction confidence from the output. For example, Transformers for natural language processing may be stacked by dividable blocks, and the confidence can be interpreted from the largest value in its output vector. Therefore, it is possible to apply DyCE for Transformer architecture.

Further, it is to be noted that a part of the backbone with an early exit network can be considered a smaller version of the original model. Early exits and the final exit match the student and teacher model concepts in knowledge distillation. Therefore, instead of choosing ground truth labels as the target, early exits can be trained to minimize the differences between early predictions and the final for any inputs. This would allow building or finetuning the dynamic compression model (DyCE) system without a labelled dataset if the pretrained model exists. Using unlabelled data means much easy to acquire data, and early exits can keep learning from any inputs to this system.

Further, because every exit is independent, this system can be modified to assign different tasks for each early exit, such as face recognition, object detection, and image-to-text. These early exits with different tasks can be organized in a logical order for specific applications. For the example of the face recognition task, coarse-grained classifies may be assigned for the first few exit positions telling if there are objects in front of the camera. The next few early exits may be fine-grained classifies to confirm a human face in sight. After that, the last few early exits may run the regular recognition task. Having a high performance for a small network is difficult, but it is still possible to get rough answers with limited computation. The early exits attached to the shallow layers may focus on easy but usual sub-tasks.

In an embodiment of the present invention, the early-exit system treats the model in a hierarchy. The feature of each early-exit network that can output independently makes it possible to store the model in parts and execute the inference on different devices. The use case could be running the first few layers on a local device while hosting the rest of model remotely. In this case, most simple jobs can be done locally to have fast response, reduce communications and alleviate privacy issues. In an example, a deep network may split into multiple parts and store its initial part only on the end device with minimal memory or computing capability. The inference may exit with a very short latency if the early exit network of that part is enough to give an acceptable result. For complex events, the end device may transmit that sample to edge devices or cloud servers for further inferences. This scheme deals with most samples locally to provide real-time feedback but also tackles complex events by using large networks on remote servers.

In an embodiment of the present invention, all early exits are required to have the same output format as the original network. However, they are not necessarily the same as every exit is independent from each other. The different early exits can be trained for different tasks sharing the same backbone. For example, for face recognition problem, an early exit can use a small part of backbone to determine whether a person is in front of the camera and a late early exit can use more layers to determine who he/she is.

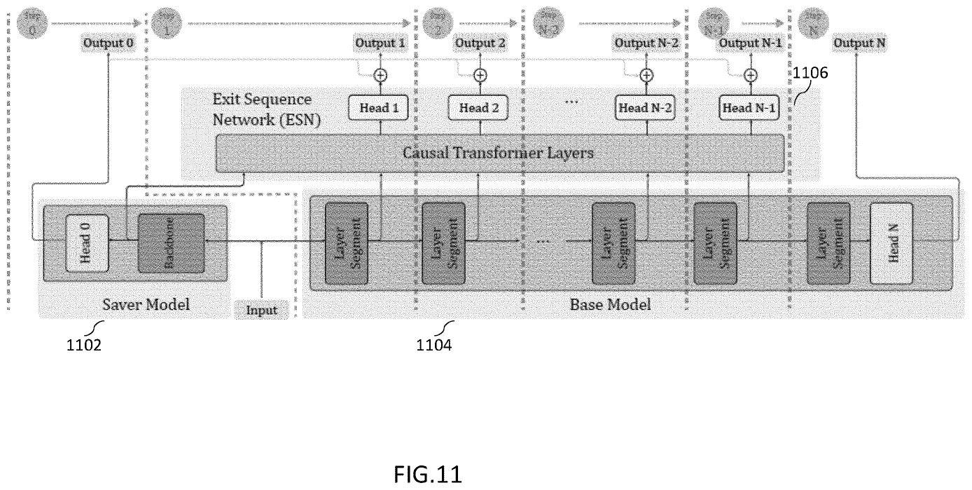

In an embodiment of the present invention, an early exit module can further be an independent model. As illustrated in FIG. 11, a tiny saver model 1102 is integrated with the base model 1104 which is the original model to be compressed. The tiny saver model 1102 is a tiny version of the base model 1104 and works on the same concept as the base model. The tiny saver model 1102 may be hereinafter alternatively referred to as an independent model 1102 and the base model 1104 is an original deep neural network that is to be compressed and scaled.

The independent model 1102 is connected to a first exit of the proposed system, such that the independent model 1102 receives the same input as the base model is pretrained on a task similar to that of the base model. The pre-trained tiny models may be more efficient than attached exits.

There is further provided an Exit Sequence Network (ESN) 1106 between the backbone of the base model and the plurality of exit modules such that the plurality of early exit modules is connected to different positions of the ESN 1106. The ESN 1106 includes a plurality of sequential layers to provide aggregated features from the independent model and the plurality of backbone segments to the plurality of early exit modules. The ESN 1106 is designed to collects features provided by the saver model 1102 and establish them as a foundation for exits attached to the backbone of the base model 1104. This approach preserves all the benefits of the early exit strategy and further integrates the saver model into the existing network. It enables intermediate exits to merge progressively refined features from the base model with high-level features from the saver model, offering trade-offs at different levels in predictions. Similar to other Early-exit-based models, the heads built on the ESN is not necessarily having uniquely includes the tiny model, ensuring a lower bound of performance.

Employing an independent, pre-trained tiny model as the first exit, has advantages to conventional early exit methods which includes training exits based on existing backbones or an early exit model from scratch. The main advantages are: 1) No training required. The tiny saver model 1102 uses pre-trained model under the same task as is. 2) Easy integration and upgrading. The tiny model (first early exit) is running separately, making it easily deployed with an existing system. The systematic performance can also be upgraded if better tiny models are invented in the future. 3) Better performance.

The invention is not limited to the embodiments hereinbefore described but may be varied in both construction and detail.

In the specification, the terms “comprise, comprises, comprised and comprising” or any variation thereof and the terms include, includes, included and including” or any variation thereof are considered to be interchangeable, and they should all be afforded the widest possible interpretation and vice versa.

1. A computer-implemented method for dynamically compressing and scaling a base model during run-time, wherein the base model is a deep neural network containing a task-specific head and a backbone, wherein the backbone is divided into a plurality of segments, the computer-implemented method comprising:
providing a plurality of candidate early exit modules and corresponding plurality of candidate threshold values for each segment, wherein an early exit module is configured to be connected to an output of a segment, to enable early exiting of the base model from said segment when an intermediate output of the early exit module reports a confidence value higher than associated threshold value;
heuristically searching a plurality of optimal early exit configurations for the base model, based on a plurality of combinations of accuracy and complexity with respect to the base model, wherein an early exit configuration enumerates which early exit module and what threshold value to be used at output of each segment;
loading an optimal early exit configuration onto the base model during run-time, to connect at most one early exit module to each segment according to said configuration; and
running the backbone part of the base model segment by segment and ending the run-time at a segment when a confidence value of an output of corresponding early exit module exceeds corresponding threshold value.

2. The computer-implemented method as claimed in claim 1 further comprising switching among the plurality of optimal early exit configurations during run-time to implement dynamic compression and scaling of the base model to meet real-time demand of the user.

3. The computer-implemented method as claimed in claim 1, wherein the plurality of candidate early exit models has varying sizes and architectures with respect to each other.

4. The computer-implemented method as claimed in any preceding claim, further comprising:
freezing the base model for training the plurality of candidate early exit models at each segment collectively or individually based on a training dataset similar to that used for training the base model.

5. The computer-implemented method as claimed in any preceding claim, wherein each early exit module comprises:
an early exit function for receiving an output of a previous segment and generating an intermediate output; and
a decision function for deciding whether to exit early or not by comparing a confidence value of the intermediate output with an associated threshold value, continuing the computation to a next segment, when the confidence value is less than the associated threshold, and exit the computing from the backbone network with the intermediate output as a final output, when the confidence value is greater than or equal to the associated threshold.

6. The computer-implemented method as claimed in any preceding claim, wherein the heuristic searching comprises employing a circular search that includes:
initiating an empty early exit configuration; and
modifying early exit module and associated threshold value of each segment in a circular fashion iteratively till an object function of said configuration is not minimizable further, wherein the object function is proportional to a trade-off factor, and complexity and accuracy of said configuration relative to that of the base model, and wherein the trade-off factor is a parameter to control weighting of the accuracy and complexity.

7. The computer-implemented method as claimed in any preceding claim, wherein the heuristic searching comprises employing a singular search that includes:
initiating an empty early exit configuration; and
modifying early exit module and associated threshold value of first to last segments sequentially to obtain an early exit configuration with minimized object function.

8. The computer-implemented method as claimed in any preceding claim, further comprising storing the plurality of optimal configurations with simulated compression rate, accuracy loss, and trade-off factors, with respect to that of the base model on a common training dataset.

9. The computer-implemented method as claimed in any preceding claim, wherein the complexity and accuracy of an early exit configuration is directly proportional to threshold values of corresponding early exit modules.

10. The computer-implemented method as claimed in any preceding claim, further comprising:
using an independent model as the first exit of the base model, such that the independent model receives the same input as the base model and is pretrained on a task similar to that of the base model; and
providing an exit sequence network between backbone networks and the plurality of exit modules such that the plurality of early exit modules is connected to different positions of the exit sequence network, wherein the exit sequence network includes a plurality of sequential layers to provide aggregated features from the independent model and the plurality of backbone segments, to the plurality of early exit modules.

11. The computer-implemented method as claimed in claim 10, wherein the exit sequence network comprises:
a plurality of feature embedding layers to convert the features from the independent model and backbone segments to a uniform format.

12. A system for dynamically compressing and scaling a base model during run-time, wherein the base model is a deep neural network containing a task-specific head and a backbone, and wherein the backbone is divided into a plurality of segments, the system comprising:
a memory to store one or more instructions; and
a processor configured to execute the one or more instructions stored in the memory to:
provide a plurality of candidate early exit modules and corresponding plurality of candidate threshold values for each segment, wherein an early exit module is configured to be connected to an output of a segment, to enable early exiting of the base model from said segment when an intermediate output of the early exit module reports a confidence value higher than associated threshold value;
heuristically search a plurality of optimal early exit configurations for the base model, based on a plurality of combinations of accuracy and complexity with respect to the base model, wherein an early exit configuration enumerates which early exit module and what threshold value to be used at output of each segment;
load an optimal early exit configuration onto the base model during run-time, to connect at most one early exit module to each segment according to said configuration; and
run the backbone part of the base model segment by segment and end the run-time at a segment when a confidence value of an output of corresponding early exit module exceeds corresponding threshold value.

13. The system as claimed in claim 12, wherein the processor is further configured to execute the one or more instructions stored in the memory to enable the base model to switch among the plurality of optimal early exit configurations during run-time to implement dynamic compression and scaling of the base model to meet real-time demand of the user.

14. A non-transitory computer readable medium having stored thereon computer-executable instructions which, when executed by a processor, cause the processor to:
divide a base model into a task-specific head and a backbone comprising a plurality of segments;
provide a plurality of candidate early exit modules and corresponding plurality of candidate threshold values for each segment, wherein an early exit module is configured to be connected to an output of a segment, to enable early exiting of the base model from said segment when an intermediate output of the early exit module reports a confidence value higher than associated threshold value;
heuristically search a plurality of optimal early exit configurations for the base model, based on a plurality of combinations of accuracy and complexity with respect to the base model, wherein an early exit configuration enumerates which early exit module and what threshold value to be used at output of each segment;
load an optimal early exit configuration onto the base model during run-time, to connect at most one early exit module to each segment according to said configuration; and
run the backbone part of the base model segment by segment and ending the run-time at a segment when a confidence value of an output of corresponding early exit module exceeds corresponding threshold value.
